(19) United States
(12) Patent Application Publication
(10) Pub. No.: US 2010/0034583 A1
(43) Pub. Date: Feb. 11, 2010

(54) COMPONENT JOINING

(75) Inventor: Samuel Leyton Simpson, Nottingham (GB)

Correspondence Address: OLIFF & BERRIDGE, PLC, P.O. BOX 320850, ALEXANDRIA, VA, 22320-4850, US

(73) Assignee: Rolls-Royce PLC, London (GB)

(21) Appl. No.: 12/449,772

(22) PCT Filed: Mar. 3, 2008
(86) PCT No.: PCT/GB2008/000729

§ 371 Date: Sep. 3, 2009

(30) Foreign Application Priority Data
Mar. 28, 2007 (GB) 0705938.9

(51) Int. Cl. F16B 5/02

(52) U.S. Cl. 403/388

(57) ABSTRACT

A ductile sheet includes an aperture for receiving a threaded fastener to secure the ductile sheet to a component. The ductile sheet includes a deformable region in which the aperture is defined, the deformable region being deformable out of the plane of the ductile sheet during tightening of the threaded fastener to secure the ductile sheet to the component.

The present invention relates to component joining. In particular, but not exclusively, embodiments of the invention relate to a ductile sheet for securing to a component and to a jointed arrangement comprising first and second ductile sheets secured together. Embodiments of the invention also relate to a method for securing a first ductile sheet to a second ductile sheet.

It is desirable to be able to secure ductile sheets together such that their respective planes are generally perpendicular, whereby the ductile sheets define a T-joint, and there is often a requirement that one of the ductile sheets, which may act as a cover plate, presents a flat surface with no components projecting above the plane of the outer surface of the cover plate.

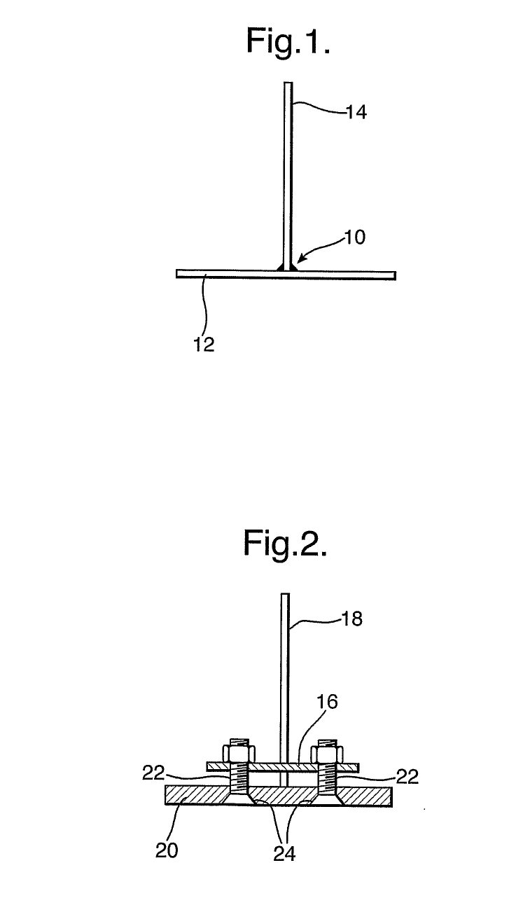

Referring to FIG. 1, one method of securing ductile sheets together to form a T-joint is to use a welded joint in which a fillet weld 10 is used to secure two ductile sheets 12, 14 together. However, welding is a complex operation requiring specialised equipment. Heat created by welding can also distort the ductile sheets 12, 14 and possibly affect their material properties and, furthermore, the resultant welded joint is permanent meaning that the ductile sheets 12, 14 cannot be easily disassembled.

Another method of securing ductile sheets together to form a T-joint is shown in FIG. 2. In this method, a retention bar 16 is located in an aperture in an anchor plate 18, and opposite ends of the retention bar 16 are secured to a cover plate 20 using threaded fasteners 22. In order to ensure that the cover plate 20 presents a flat surface, countersunk apertures 24 must be formed in the cover plate 20. This method has a number of disadvantages. For example, the cover plate 20 must be sufficiently thick to accommodate the heads of the countersunk threaded fasteners 22, and this adds cost and weight to the resultant joint. Countersunk apertures 24 must be formed in the cover plate 20, and this additional operation requires additional tooling, thus increasing cost and lead-time. The requirement for two nuts and threaded fasteners 22 and the retention bar 16 increases cost, weight and assembly time. Another problem is that the retention bar 16 can distort during tightening of the threaded fasteners 22.

It would therefore be desirable to be able to form a jointed arrangement, having a T-joint, in which the abovementioned disadvantages are reduced.

According to one aspect of the present invention, there is provided a jointed arrangement comprising a first ductile sheet and a component, wherein the first ductile sheet includes an aperture for receiving a threaded fastener the fastener engaging a threaded nut to secure the ductile sheet to the component, wherein the ductile sheet includes a deformable region in which the aperture is defined whereby the deformable region is deformable out of the plane of the ductile sheet during tightening of the threaded fastener to secure the ductile sheet to the component.

The component may include a recess in which the deformable region of the first ductile sheet is received following tightening of the threaded fastener to secure the first ductile sheet to the second ductile sheet.

Preferably the component includes a passage, extending from the recess for receiving a threaded shank of the threaded fastener.

The passage may include a nut receiving portion for receiving the threaded nut in which the threaded shank of the threaded fastener is locatable to thereby secure the first ductile sheet to the component.

The nut receiving portion may include an anti-rotation region which is operable to prevent rotation of the threaded nut during rotation of the threaded shank of the threaded fastener relative to the threaded nut.

The edges of the passage may be tapered to define the anti-rotation region. The edges of the passage may include inwardly directed projections to define the anti-rotation region.

The component may include apertures substantially adjacent to the inwardly directed projections to permit localised deformation of the second ductile sheet.

Preferably the component includes a nut retaining member which is locatable in an aperture of the threaded nut to retain the nut in the nut receiving portion prior to insertion of the threaded shank of the threaded fastener into the aperture of the threaded nut.

Preferably the nut retaining member is displaceable out of the aperture of the threaded nut by the threaded shank of the threaded fastener during tightening rotation of the threaded fastener.

Preferably the first ductile sheet includes at least one locating recess and the component includes at least one complementary locating projection.

Preferably the component is in the form of a second ductile sheet to which the first ductile sheet (32, 132) is secured, wherein the first ductile sheet is secured along an edge of the second ductile sheet such that the planes of the first and second ductile sheets are generally perpendicular.

Preferably the aperture in the first ductile sheet is defined substantially centrally in the deformable region.

The aperture may be defined by an annular member.

The deformable region may comprises a plurality of deformable ribs extending between the ductile sheet and the annular member to support the annular member and enable its deformation out of the plane of the ductile sheet during tightening of the threaded fastener.

Preferably the deformable ribs are in the form of spokes. The deformable ribs may be of generally helical or spiral configuration.

Preferably there is provided a method for securing a first ductile sheet along an edge of a second ductile sheet with the planes of the first and second ductile sheets generally perpendicular, the first ductile sheet including a deformable region in which an aperture is defined, the method comprising locating a threaded fastener in the aperture and causing engagement of the threaded fastener with a threaded formation of the second ductile sheet, and rotating the threaded fastener to tighten it such that tightening rotation of the threaded fastener deforms the deformable region out of the plane of the first ductile sheet and into a recess defined in the second ductile sheet.

The method may comprise rotating the threaded fastener to deform the deformable region such that a head of the threaded fastener may be substantially coplanar with the plane of the first ductile sheet following deformation of the deformable region.

The method may comprise rotating the threaded fastener to deform the deformable region such that a head of the threaded fastener may extend partially into the recess in the second ductile sheet following deformation of the deformable region.

Embodiments of the present invention will now be described by way of example only and with reference to the accompanying drawings, in which:—

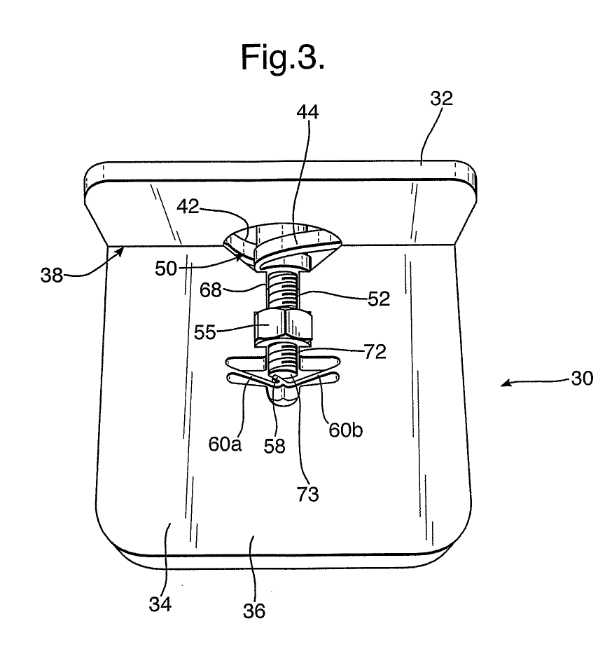

FIG. 3 is a diagrammatic perspective view of a jointed arrangement;

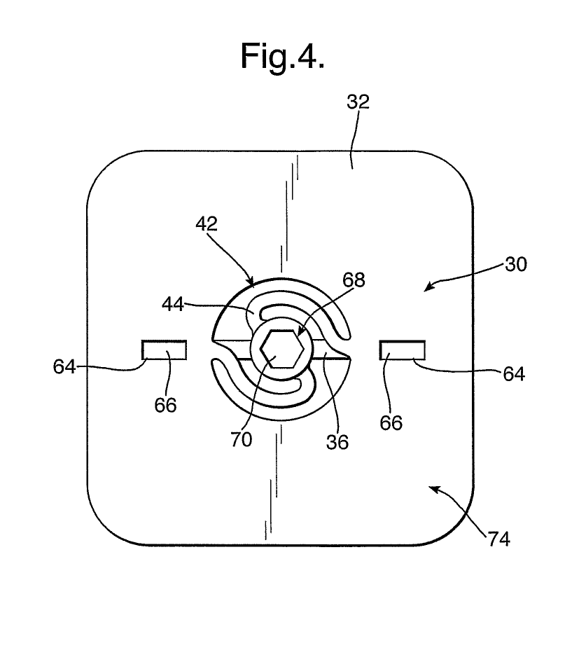

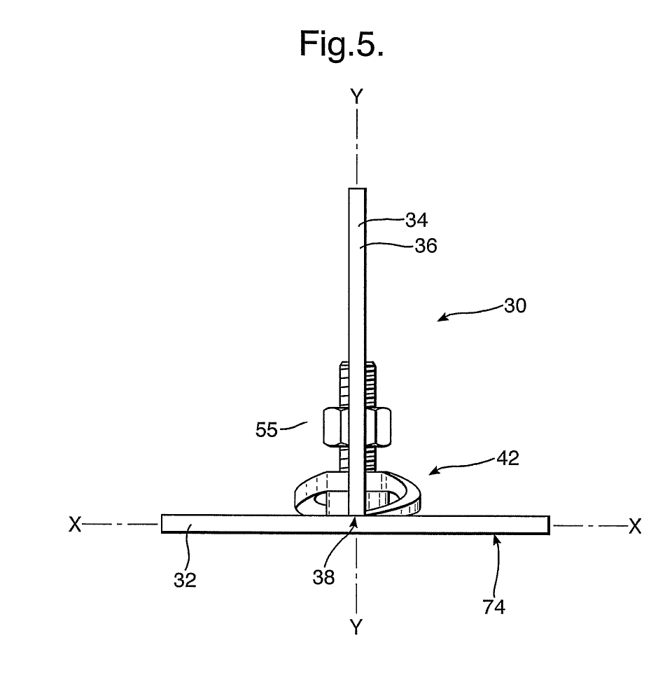

FIGS. 4 and 5 are further diagrammatic views of the jointed arrangement of FIG. 3;

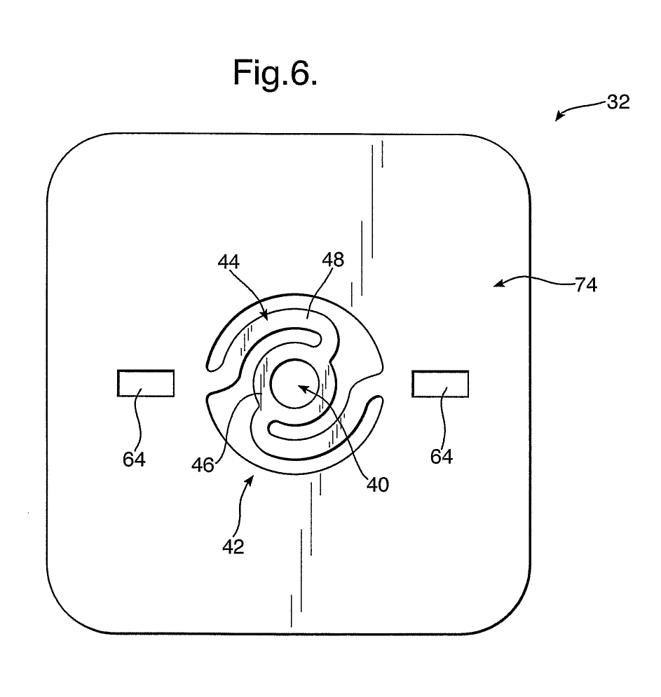

FIG. 6 is a diagrammatic plan view of a first ductile sheet of the jointed arrangement of FIGS. 3 to 5;

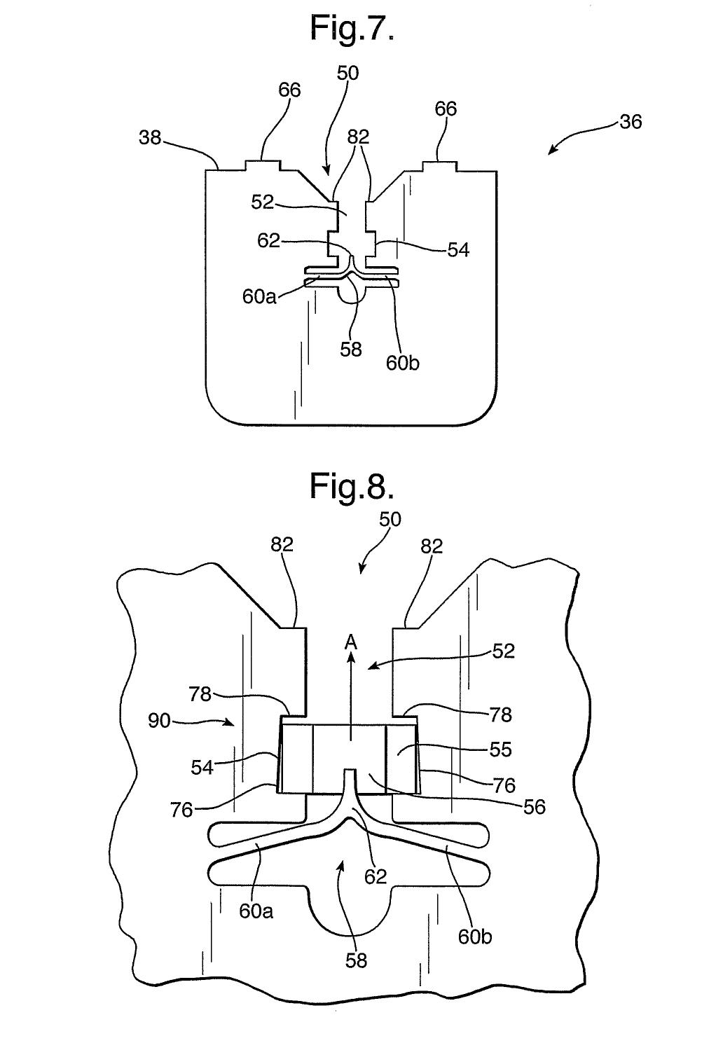

FIG. 7 is a diagrammatic side view of a second ductile sheet of the jointed arrangement of FIGS. 3 to 5;

FIG. 8 is an enlarged diagrammatic view of part of the jointed arrangement of FIGS. 3 to 5;

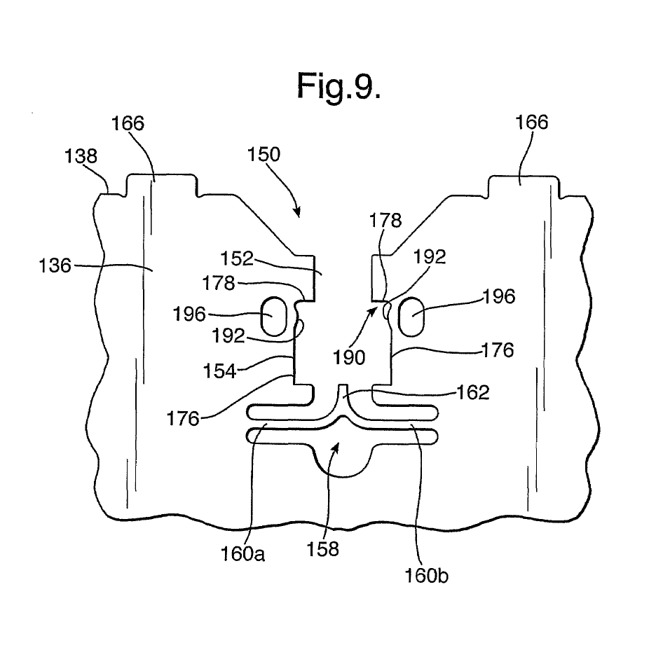

FIG. 9 is a diagrammatic view of part of a alternative second ductile sheet for an alternative jointed arrangement;

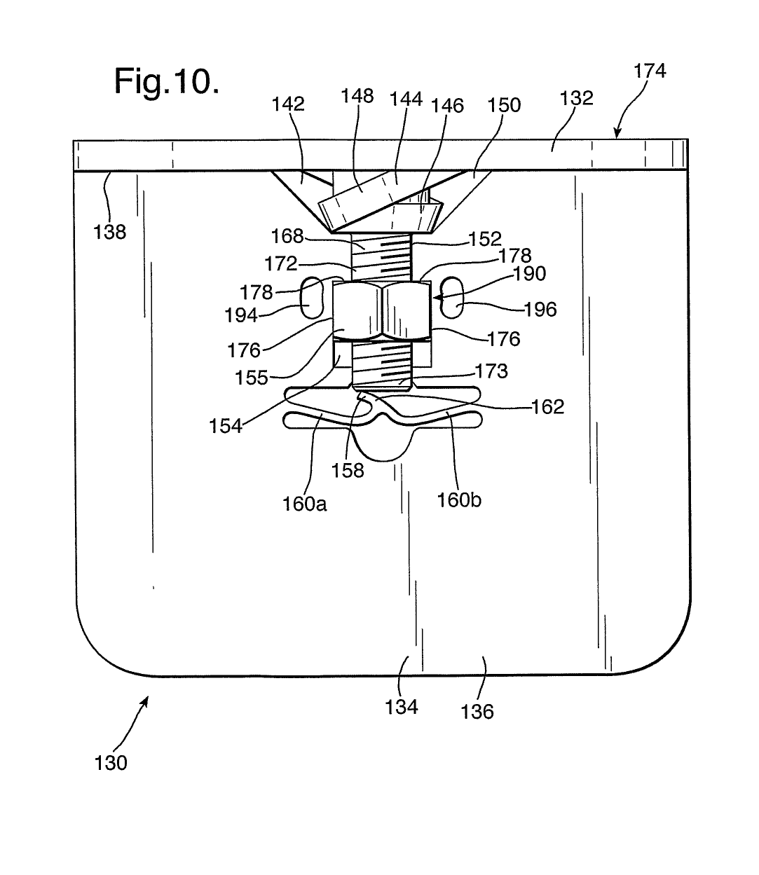

FIG. 10 is a diagrammatic view of an alternative jointed arrangement including the alternative second ductile sheet of FIG. 9; and

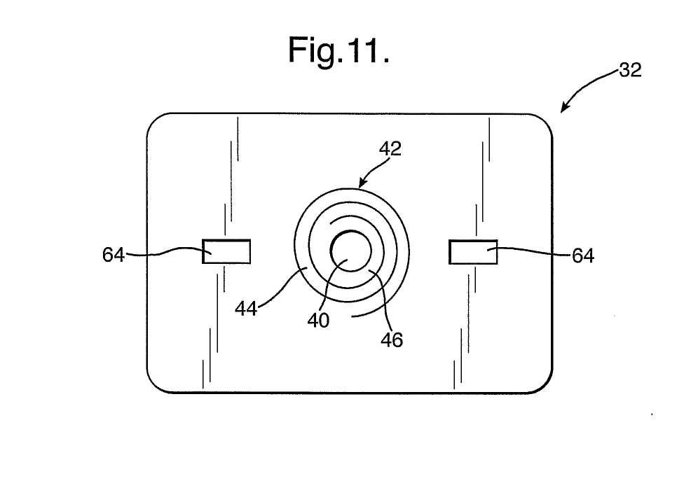

FIG. 11 is a diagrammatic plan view of an alternative first ductile sheet.

Referring to the drawings, there is shown a jointed arrangement 30 in which a first ductile sheet 32 is secured to a component 34 in the form of a second ductile sheet 36. The first ductile sheet 32 is secured along an edge 38 of the second ductile sheet 36 in such a way that respective planes X-X and Y-Y of the first and second ductile sheets 32, 36 are generally perpendicular. The resulting joint thereby defined between the first and second ductile sheets 32, 36 is a T-joint.

The first ductile sheet 32 includes a deformable region 42 in substantially the centre of which is located an aperture 40. The deformable region 42 generally comprises a plurality of deformable ribs 44 extending between the first ductile sheet 32 and the aperture 40 which is defined by a generally annular ring member 46. In the embodiment illustrated in FIG. 6, the deformable ribs 44 are in the form of spokes 48. The deformable ribs 44 and the annular member 46 defining the aperture 40 are formed by removing appropriate material from the first ductile sheet 32, for example by stamping or another suitable metalworking operation.

Referring in particular to FIGS. 3 and 7, it will be seen that the second ductile sheet 36 defines a recess 50. The recess 50 extends into a passage 52 which, as can be seen clearly in FIG. 8, includes a nut receiving portion 54 for receiving a conventional nut 55 having an internally threaded aperture 56. In order to initially retain the nut 55 within the nut receiving portion 54, the second ductile sheet 36 includes a nut retaining member 58.

Referring initially to FIG. 7, it will be seen that the nut retaining member 58 comprises two lateral members 60a, 60b and an upstanding member 62. Following location of the nut 55 within the nut receiving portion 54, as shown in FIG. 8 the lateral members 60a, 60b can be deformed in such a way that the upstanding member 62 enters the internally threaded aperture 56 of the nut 55. Location of the upstanding member 62 in the aperture 56 provides sufficient constraint to the nut 55 so that it is unable to fall sideways out of the nut receiving portion 54.

When it is desired to secure the first and second ductile sheets 32, 36 together to form a jointed arrangement 30 having a T-joint, the first and second ductile sheets 32, 36 are located relative to each other with their respective planes X-X and Y-Y generally perpendicular, such that the deformable region 42 of the first ductile sheet 32 is located substantially adjacent to the recess 50 in the second ductile sheet 36.

In order to facilitate appropriate relative location of the deformable region 42 and the recess 50 in the respective first and second ductile sheets 32, 36, the first and second ductile sheets 32, 36 are provided with appropriate locating features in the form of locating recesses 64 in the first ductile sheet 32 and locating projections 66 which extend from the edge 38 of the second ductile sheet 36 and which are locatable in the locating recesses 64 in the first ductile sheet 32.

After a nut 55 has been located in the nut receiving portion 54 in the second ductile sheet 36 and the nut retaining member 58 appropriately deformed to retain the nut 55 in position in the nut receiving portion 54, and with the first and second ductile sheets 32, 36 located relative to each other to form a T-joint, a threaded fastener 68 having a head 70 and a threaded shank 72 is used to secure the first and second ductile sheets 32, 36 together.

As can be seen clearly in FIGS. 3 and 4, the threaded shank 72 is passed through the aperture 40 defined by the deformable region 42 in the first ductile sheet 32, through the recess 50 in the second ductile sheet 36 and into the passage 52 until it encounters the threaded nut 55. Upon encountering the threaded nut 55, an appropriate tool (not shown) is used to rotate the threaded fastener 68 such that the threaded shank 72 enters into threaded engagement with the threaded formation of the internally threaded aperture 56 of the nut 55. As soon as the threaded shank 72 enters into engagement with the internally threaded aperture 56, the nut 55 is adequately retained in the nut receiving portion 54 by the threaded fastener 68 and the nut retaining member 58 is no longer needed. Accordingly, during continued rotation of the threaded fastener 68 to tighten it, a tip 73 of the threaded shank 72 engages the upstanding member 62 of the nut retaining member 58 and pushes it out of the threaded aperture 56, thereby deforming the lateral members 60a, 60b.

Continued rotation of the threaded fastener 68 results in a force between the nut 55 and the annular member 46 with which the head 70 of the threaded fastener 68 is in engagement. Since the annular member 46 is supported by the deformable ribs 44, the deformable region 42, which comprises the deformable ribs 44 and the annular member 46, deforms out of the plane of the first ductile sheet 32 such that the deformable ribs 44 and the annular member 46 enter into the recess 50 in the second ductile sheet 36. This is highly advantageous as it enables the head 70 of the threaded fastener 68 to become at least coplanar with the first ductile sheet 32, or indeed under continued rotation of the threaded fastener 68 to tighten it, to at least partially enter into the recess 50 in the second ductile sheet 36. In both of these cases, entry of the deformable ribs 44 and the annular member 46 into the recess 50 in the second ductile sheet 36 ensures that the threaded fastener 68 can be tightened to a sufficient extent that the head 70 of the threaded fastener does not protrude above an outer surface 74 of the first ductile sheet 32.

In order to prevent excessive deformation of the deformable ribs 44 which could result in them being damaged, the recess 50 includes shoulders 82 against which the deformable ribs 44 abut when the threaded fastener 68 has been tightened to a sufficient extent.

The nut receiving portion 54 includes an anti-rotation region 90 which, in the embodiment of FIG. 8, is defined by tapered edges 76 of the passage 52 in the second ductile sheet 36. As the threaded fastener 68 is rotated into threaded engagement with the threaded nut 55 to tighten it and thereby secure the first and second ductile sheets 32, 36 together, the force exerted on the nut 55, when the head 70 of the threaded fastener 68 engages the annular member 46 of the deformable region 46, causes the nut 55 to move in the direction of arrow A, into abutment with shoulders 78. In this position, the distance between the tapered edges 76 is less than the outer diameter of the nut 55, thus causing localised deformation of the second ductile sheet 36 and causing the tapered edges 76 to firmly engage the nut and prevent it from rotating within the anti-rotation region 90 of the nut receiving portion 54.

FIGS. 9 and 10 illustrate an alternative embodiment in which features corresponding to the embodiment of FIGS. 3 to 8 are given the same reference numerals, prefixed by the number 1.

In the embodiment of FIGS. 9 and 10, the edges 176 of the passage 152 in the second ductile sheet 136 include inwardly directed projections 192 defining the anti-rotation region 190. The distance between innermost points of the inwardly directed projections 192 is less than the outer diameter of the nut 155. Accordingly, when the nut 155 engages the projections 192, during rotation of the threaded fastener 168 to tighten it, the force exerted on the projections 192 by the nut 155 causes localised deformation of the second ductile sheet 136, and in particular deformation of the projections 192. The nut 155 is thus firmly gripped in the anti-rotation region 190 of the nut receiving portion 154.

In order to permit deformation of the projections 192 and hence localised deformation of the second ductile sheet 136 in the region of the inwardly directed projections 192, the second ductile sheet 136 includes apertures 196 substantially adjacent to the projections 192. When a comparison is made between FIGS. 9 and 10, it will be readily seen that the apertures 196 have permitted localised deformation of the second ductile sheet 136 adjacent to the deformed projections 192.

The provision of an anti-rotation region 90, 190 obviates the need to use a spanner or other means to prevent the nut 55, 155 from rotating, and this is particularly advantageous as it will be appreciated that under some circumstances the nut 55, 155 will not be accessible when the first ductile sheet 32, 132 is positioned for fastening to the second ductile sheet 36, 136. This also has the added advantage that in the event that the threaded fastener 68, 168 needs to be removed to allow disassembly of the first and second ductile sheets 32, 132, 36, 136, it can simply be rotated in an appropriate direction whilst rotation of the nut 55, 155 will still be prevented by the anti-rotation region 90, 190, the nut 55 essentially having become jammed in the anti-rotation region 90, 190 of the nut receiving portion 54, 154 during previous tightening of the threaded fastener 68, 168. The nut 55, 155 thus typically remains secured or jammed in the nut receiving portion 54, 155 even after removal of the threaded fastener 68, 168.

FIG. 11 shows an alternative form of first ductile sheet 32 in which the deformable ribs 44 are generally spiral or helical and are formed by providing a spiral or helical cut through the material of the first ductile sheet 32, centred on the aperture 40.

Although embodiments of the invention have been described in the preceding paragraphs with reference to various examples, it should be appreciated that various modifications to the examples given may be made without departing from the scope of the present invention, as claimed.

For example, any suitable form of threaded fastener 68 may be used to secure the first and second ductile sheets 32, 36 together. The component 34 does not necessarily have to be in the form of a ductile sheet and could alternatively be any suitably shaped component. The deformable region 42 may be of any suitable configuration and formed by any suitable method.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A jointed arrangement comprising a first ductile sheet and a component, wherein the first ductile sheet includes an aperture for receiving a threaded fastener the fastener engaging a threaded nut to secure the ductile sheet to the component, wherein the ductile sheet includes a deformable region in which the aperture is defined whereby the deformable region is deformable out of the plane of the ductile sheet during tightening of the threaded fastener to secure the ductile sheet to the component.

2. A jointed arrangement according to claim 1, wherein the component includes a recess in which the deformable region of the first ductile sheet is received following tightening of the threaded fastener to secure the first ductile sheet (to the second ductile sheet.

3. A jointed arrangement according to claim 1, wherein component includes a passage, extending from the recess for receiving a threaded shank of the threaded fastener.

4. A jointed arrangement according to claim 3, wherein the passage includes a nut receiving portion for receiving the threaded nut in which the threaded shank of the threaded fastener is locatable to thereby secure the first ductile sheet to the component.

5. A jointed arrangement according to claim 4, wherein the nut receiving portion includes an anti-rotation region which is operable to prevent rotation of the threaded nut during rotation of the threaded shank of the threaded fastener relative to the threaded nut.

6. A jointed arrangement according to claim 5, wherein edges of the passage are tapered to define the anti-rotation region.

7. A jointed arrangement according to claim 5, wherein edges of the passage include inwardly directed projections to define the anti-rotation region.

8. A jointed arrangement according to claim 7, wherein the component includes apertures substantially adjacent to the inwardly directed projections to permit localised deformation of the second ductile sheet.

9. A jointed arrangement according to any of claim 4, wherein the component includes a nut retaining member which is locatable in an aperture of the threaded nut to retain the nut in the nut receiving portion prior to insertion of the threaded shank of the threaded fastener into the aperture of the threaded nut.

10. A jointed arrangement according to claim 9, wherein the nut retaining member is displaceable out of the aperture of the threaded nut by the threaded shank of the threaded fastener during tightening rotation of the threaded fastener.

11. A jointed arrangement according to claim 1, wherein the first ductile sheet includes at least one locating recess and the component includes at least one complementary locating projection.

12. A jointed arrangement according to claim 1 wherein the component is in the form of a second ductile sheet to which the first ductile sheet is secured, wherein the first ductile sheet is secured along an edge of the second ductile sheet such that the planes of the first and second ductile sheets are generally perpendicular.

13. A joined arrangement according to claim 1, wherein the aperture in the first ductile sheet is defined substantially centrally in the deformable region.

14. A joined arrangement according to claim 1, wherein the aperture is defined by an annular member.

15. A joined arrangement according to claim 14, wherein the deformable region comprises a plurality of deformable ribs extending between the ductile sheet and the annular member to support the annular member and enable its deformation out of the plane of the ductile sheet during tightening of the threaded fastener.

16. A joined arrangement according to claim 15, wherein the deformable ribs are in the form of spokes.

17. A joined arrangement according to claim 15, wherein the deformable ribs are of generally helical or spiral configuration.
